(19) United States
(12) Patent Application Publication
(10) Pub. No.: US 2014/0059748 A1
(43) Pub. Date: Mar. 6, 2014

(54) EASILY WORN AND REMOVED WATER SPORTS GARMENT

(71) Applicant: Heng-Wen Shiue, Yilan County (TW)

(72) Inventor: Heng-Wen Shiue, Yilan County (TW)

(73) Assignee: SHEI CHUNG HSIN IND. CO., LTD., Yilan County (TW)

(21) Appl. No.: 13/605,986

(22) Filed: Sep. 6, 2012

(51) Int. Cl. A41D 13/00; B32B 27/02; A41D 7/00; B32B 5/18

(52) U.S. Cl. 2/456; 428/319.3; 2/67

(57) ABSTRACT

A silky waterproof material for water sports garment is provided. The waterproof material is a foamed rubber sheet sandwiched by an inner silky fabric layer and an outer fabric layer. The warp elasticity of the inner silky fabric layer is smaller than 50%, and the weft elasticity of the inner silky fabric layer is greater than 100%.

### BACKGROUND

1. Technical Field

The disclosure relates to a garment. More particularly, the disclosure relates to a water sports garment.

2. Description of Related Art

Waterproof wears are commonly used in water sports, such as diving, surfing and canoeing. The waterproof wears that are used in water sports must have the characteristics of lightweight, elasticity, buoyancy, being easy to put on and take off and tactual comfort of skin contact in order to allow the wearer to keep warm and to move without substantial constraints.

The most commonly used material for waterproof wears is a foamed rubber sheet sandwiched by two layers of fabrics. However, most waterproof wears are still difficult to put on and take off to an extent.

### SUMMARY

Accordingly, an aspect of this invention is to provide a silky waterproof material for water sports garment. The waterproof material is a foamed rubber sheet sandwiched by an inner silky fabric layer and an outer fabric layer. The warp elasticity of the inner silky fabric layer is smaller than 50%, and the weft elasticity of the inner silky fabric layer is greater than 100%.

According to an embodiment, the fibers of the silky fabric layer comprise synthetic fibers. The synthetic fibers can be made from polyamide, polyester, polypropylene, or a combination thereof.

According to another embodiment, the fibers of the silky fabric layer are 15-150 denier.

According to another embodiment, the fabric density of the silky fabric layer is 45-65/35-60 warp/fill.

According to yet another embodiment, the silky fabric layer is plain or fillister weaved.

According to yet another embodiment, an exposed surface of the silky fabric layer is treated by a smoothness softener.

According to yet another embodiment, the smoothness softener is a silicone type smoothness softener.

Another aspect of this invention is to provide a water sports garment comprising the silky waterproof material above.

According to an embodiment, the silky waterproof material is used in areas covering the arms, legs, or a combination thereof.

The forgoing presents a simplified summary of the disclosure in order to provide a basic understanding to the reader. This summary is not an extensive overview of the disclosure and it does not identify key/critical elements of the present invention or delineate the scope of the present invention. Its sole purpose is to present some concepts disclosed herein in a simplified form as a prelude to the more detailed description that is presented later.

Many of the attendant features will be more readily appreciated as the same becomes better understood by reference to the following detailed description considered in connection with the accompanying drawings.

### BRIEF DESCRIPTION OF THE DRAWINGS

FIG. 1 is a perspective diagram of a waterproof material according to an embodiment of this invention.

FIGS. 2A and 2B are diagrams of performing a pulling test.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### Silky Waterproof Material and Water Sports Garments

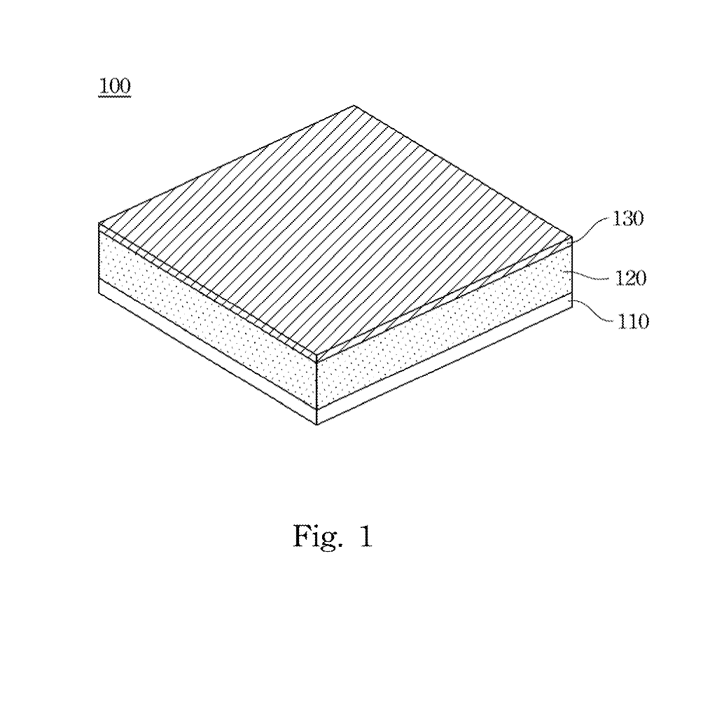

FIG. 1 is a perspective diagram of a silky waterproof material according to an embodiment of this invention. In FIG. 1, the silky waterproof material 100 is formed by a foamed rubber sheet 120 sandwiched by an inner silky fabric layer 130 and an outer fabric layer 110.

The fibers of the inner silky fabric layer 130 comprise synthetic fibers. The material of the synthetic fibers can be polyamide, polyester, polypropylene, or a combination thereof, for example. The fibers of the silky fabric layer 130 can be filament or textured yarn.

To decrease the resistance of putting on and taking off a water sports garment comprising of the silky waterproof material 100, it is better to increase the flatness of the silky fabric layer 130. In one aspect, the flatness of the silky fabric layer 130 can be increased by decreasing the denier of the fibers of the silky fabric layer 130. The denier of the fibers of the silky fabric layer 130 can be 15-150 denier, such as 40-50 denier.

In another aspect, the flatness of the silky fabric layer 130 can be increased by using certain filaments as the fibers of the silky fabric layer 130. For example, the fibers can be semi-dull filament.

In yet another aspect, the flatness of the silky fabric layer 130 can be increased by increasing the fabric density of the silky fabric layer 130. For example, the fabric density of the silky fabric layer 130 can be 45-65/35-60 warp/fill, such as 53/56 warp/fill.

In yet another aspect, the flatness of the silky fabric layer 130 can be also increased by using plain or fillister weaves. The silky fabric layer 130 can be woven by a circular knitting machine, and the needle count can be 28-44 gauge/inch, such as 36-40 gauge/inch.

Furthermore, the fibers of the silky fabric layer 130 can further comprise spandex yarns to increase the wearing comfort, and the spandex yarns can be 10-40 denier, such as 15-20 denier.

For putting on and taking off a water sports garment comprising of the silky water proof material 100 by a wearer more easily, the silky fabric layer 130 is further treated by a heat setting treatment to decrease its warp elasticity. However, the weft elasticity is preserved at a high level to decrease the girth restraint. The warp elasticity of the silky fabric layer 130 can be less than 50%, such as 35-45%. The weft elasticity of the silky fabric layer 130 can be more than 100%, such as 125-150%.

To increase the silky feeling of the silky fabric layer 130, the filament number in each fiber of the silky fabric layer 130 is 12-72, such as 24-48.

Furthermore, the exposed surface of the silky fabric layer 130 can be further treated by a smoothness softener to increase the silky feeling of the contacting surface. The smoothness softener can be a silicone type smoothness softener.

Accordingly, the silky waterproof material 100 can be used to fabricate a water sports garment. The silky waterproof material 100 is particularly suitable to be used in areas covering the arms, legs, or a combination thereof, but is not limited thereby.

### Comparison Tests

An example of the silky fabric layer 130 is provided below. A widely-used stretch fabric for wetsuits is also provided. The related specifications are listed in Table 1 below.

TABLE 1
Related specifications of an example of the silky fabric layer 130
and a widely-used stretch fabric for wetsuits.

| Specification | | silky fabric | Stretch fabric |
|---|---|---|---|
| fibers | Material | polyamide | polyamide |
| | Denier | 50 | 40 |
| | Filament number | 48 | 12 |
| | Fiber type | filament | filament |
| | Spandex yarns | none | none |
| weave | weft knitting machine | Single surface | Double surfaces |
| | Needle count | 36 G | 36 G |

| | | |
|---|---|---|
| Fabric density (warp/fill) | 53/56 | 58/69 |

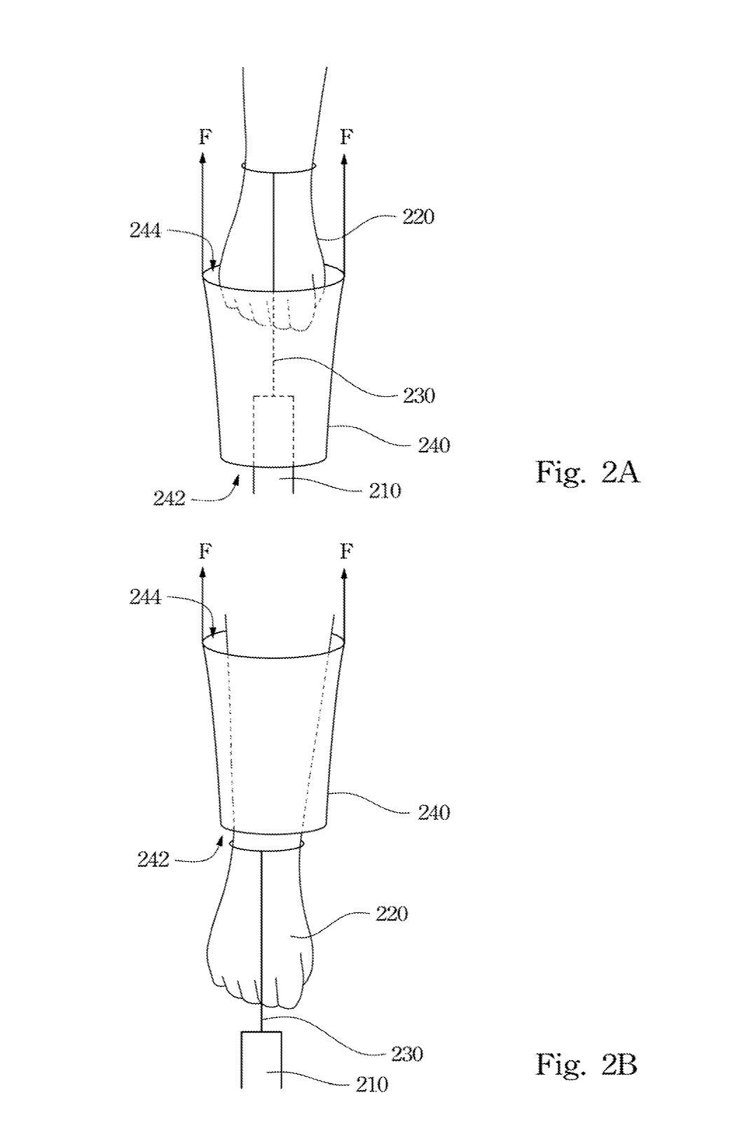

The obtained physical properties of the fabrics listed Table 1 are listed in Table 2 below. The way of performing pulling test in Table 2 is shown in FIGS. 2A and 2B and described as follow. In FIG. 2A, a human's clenched fist 220 was fixed on a holder 210 by an inelastic rope. A testing sleeve 240 made by a tested fabric is provided. The testing sleeve 240 has a first opening 242 with an inner diameter smaller than the human's clenched fist 220 but larger than the holder 210, and a second opening 244 with an inner diameter larger than the human's clenched fist 220.

When a pulling test is performed, the testing sleeve 240 is pulled upwards by a force F to guide the testing sleeve 240 past the holder 210 first, and then past the clenched fist 220. Since the first opening 242 is smaller than the clenched fist 220, it will take a greater force to pull the tested sleeve 240 past the clenched fist 220, as shown in FIG. 2B. The forces needed to pull the tested sleeve 240 through the clenched fist 220 were listed in Table 2.

TABLE 2
Physical properties of the example of the silky fabric layer 130
and the widely-used stretch fabric for wetsuits in Table 1

| Physical properties | silky fabric | Stretch fabric |
|---|---|---|
| Weight (g/m) | 64 | 98 |
| Strength (kgf/cm²) | 11.0 | 9.0 |
| Warp elasticity | 40 | 170 |
| Weft elasticity | 130 | 170 |
| Pulling test (kgw) | 8.920 | 18.016 |

From the results of Table 2, it can be known that the silky fabric is lighter and stronger than the widely-used stretch fabric. After adjusting the warp elasticity and the weft elasticity of the silky fabric, the force F needed to pull the tested sleeve passing through the clenched fist is much smaller than the widely-used stretch fabric (8.920 kgw v. 18.16 kgw). Therefore, water sports garment using the silky fabric provided above can be put on and taken off much more easily.

All the features disclosed in this specification (including any accompanying claims, abstract, and drawings) may be replaced by alternative features serving the same, equivalent or similar purpose, unless expressly stated otherwise. Thus, each feature disclosed is one example only of a generic series of equivalent or similar features.

What is claimed is:

1. A silky waterproof material consisting essentially of:
a foamed rubber sheet;
an inner silky fabric layer on a first surface of the foamed rubber sheet, wherein the warp elasticity of the inner silky fabric layer is smaller than 50%, and the weft elasticity of the inner silky fabric layer is greater than 100%; and
an outer fabric layer on a second surface of the foamed rubber sheet.

2. The silky waterproof material of claim 1, wherein the fibers of the silky fabric layer comprise synthetic fibers made from polyamide, polyester, polypropylene, or a combination thereof.

3. The silky waterproof material of claim 1, wherein fibers of the silky fabric layer are 15-150 denier.

4. The silky waterproof material of claim 1, wherein fabric density of the silky fabric layer is 45-65/35-60 warp/fill.

5. The silky waterproof material of claim 1, wherein the silky fabric layer is plain or fillister weaved.

6. The silky waterproof material of claim 1, wherein an exposed surface of the silky fabric layer is treated by a smoothness softener.

7. The silky waterproof material of claim 6, wherein the smoothness softener is a silicone type smoothness softener.

8. A water sports garment, comprising:
the silky waterproof material of claim 1, wherein the first surface of the foamed rubber sheet is located on the inner side of the water sports garment.

9. The water sports garment of claim 8, wherein the silky waterproof material is used in areas covering the arms, legs, or a combination thereof.

10. The water sports garment of claim 8, wherein the fibers of the silky fabric layer comprise synthetic fibers made from polyamide, polyester, polypropylene, or a combination thereof.

11. The water sports garment of claim 8, wherein fibers of the silky fabric layer are 15-150 denier.

12. The water sports garment of claim 8, wherein fabric density of the silky fabric layer is 45-65/35-60 warp/fill.

13. The water sports garment of claim 8, wherein the silky fabric layer is plain or fillister weaved.

14. The water sports garment of claim 8, wherein an exposed surface of the silky fabric layer is treated by a smoothness softener.

15. The water sports garment of claim 14, wherein the smoothness softener is a silicone type smoothness softener.
